(19) United States
(12) Patent Application Publication
(10) Pub. No.: US 2015/0099026 A1
(43) Pub. Date: Apr. 9, 2015

(54) INJECTION MOLDING SYSTEM CAPABLE OF DETECTING PRESSURE ABNORMALITY

(71) Applicant: FANUC Corporation, Yamanashi (JP)

(72) Inventor: Wataru SHIRAISHI, Yamanashi (JP)

(21) Appl. No.: 14/506,727

(22) Filed: Oct. 6, 2014

(30) Foreign Application Priority Data
Oct. 7, 2013 (JP) 2013-209927

(51) Int. Cl. B29C 45/77; B29C 45/84

(52) U.S. Cl. CPC B29C 45/77; B29C 45/84; B29C 2945/76006; B29C 2945/7621; B29C 2945/76254; B29C 2945/76214; B29C 2945/76381; B29C 2945/76973; B29C 2945/76943; B29C 2945/76558
USPC 425/170

(57) ABSTRACT

An injection molding system includes an injection molding machine and a data management device. The injection molding machine includes an abnormality detection unit that detects an abnormality of a pressure on a resin in an injection cylinder, and the data management device includes a data storage unit that stores abnormality detection data on the resin pressure, including a resin pressure value obtained when the abnormality of the resin pressure is detected by the abnormality detection unit and the time and date of detection of the abnormality. Further, the injection molding machine includes a data analysis unit that analyzes the abnormality detection data and a determination unit that determines whether or not to output an alarm, based on the result of analysis of the abnormality detection data.

### BACKGROUND OF THE INVENTION

1. Field of the Invention

The present invention relates to an injection molding system capable of detecting pressure abnormality.

2. Description of the Related Art

FIG. 14 is a view showing the entire configuration of an injection molding machine. The injection molding machine comprises a mold clamping unit Mc and an injection unit Mi mounted on a machine base. The injection unit Mi heats and melts a resin material (pellets) and injects the resulting molten resin into a cavity of a mold 40. The mold clamping unit Mc mainly opens and closes the mold 40 (movable- and fixed-side molds 40a and 40b).

The injection unit Mi will be described first. A nozzle 12 is mounted on the distal end of a cylinder 11, and a screw 13 is inserted in the cylinder 11. The screw 13 is rotated by a servomotor M2 and axially moved by a servomotor M1. Reference numeral 14 denotes a hopper for feeding the resin material to the injection cylinder 11.

The mold clamping unit Mc will be described next. The mold clamping unit Mc comprises a movable platen 30, rear platen 31, toggles 32, fixed platen 33, crosshead 34, servomotors M3 and M4, and ball screw shaft 38. The servomotor M3 serves to move the movable platen 30 forward and backward. The servomotor M4 is used to push out an ejector pin for ejecting a molded article from the mold. The ball screw shaft 38 is driven by the servomotor M3.

The rear platen 31 and the fixed platen 33 are connected by the tie bars 41, and the movable platen 30 is disposed so as to be guided by the tie bars 41.

The movable-side mold 40a and the fixed-side mold 40b, constituting the mold 40, are attached to the movable platen 30 and the fixed platens 33, respectively. The position of the movable platen 30 can be changed by advancing or retracting the crosshead 34 on the ball screw shaft 38, which is driven by the servomotor M3. If the crosshead 34 is advanced (to the right in FIG. 14), in this case, the movable platen 30 is advanced to close the mold. Then, a mold clamping force equivalent to the product of a toggle magnification and a propulsive force produced by the servomotor M3 is generated and used for mold clamping.

The following is a description of a molding operation using the injection molding machine described above. If the servomotor M3 is rotated forward, the ball screw shaft 38 is rotated forward. Thereupon, the crosshead 34 engaged with the ball screw shaft 38 is advanced (to the right in FIG. 14), and the movable platen 30 connected to the toggles 32 advances.

When the movable-side mold 40a on the movable platen 30 contacts the fixed-side mold 40b (mold closing state), a mold clamping process is started. In the mold clamping process, the servomotor M3 is further driven forward, whereupon the mold clamping force is generated in the mold 40. As the servomotor M1 in the injection unit Mi is driven so that the screw 13 is axially advanced, the molten resin is filled into a cavity space in the mold 40. If the servomotor M3 is driven in the reverse direction to open the mold, the ball screw shaft 38 is reversely rotated. As this is done, the crosshead 34 is retracted, and the movable platen 30 is retracted toward the rear platen 31. When the mold opening process is completed, the servomotor M4, which serves to push out the ejector pin (not shown) for ejecting the molded article from the movable-side mold 40a, is activated. Thereupon, the ejector pin projects from the inner surface of the movable-side mold 40a, thereby ejecting the molded article from the movable-side mold 40a.

In the injection unit Mi of the injection molding machine constructed in this manner, the cylinder 11 for melting and injecting the resin repeatedly extends and contracts in each injection cycle, so that it is subjected to load due to the resin pressure. Also, the nozzle 12, screw 13, and other components that constitute the injection unit Mi are subjected to load due to the resin pressure. In some cases, therefore, a sudden pressure increase occurs due to clogging of the nozzle 12, so that the components of the injection unit Mi may suffer progressive metal fatigue, resulting in reduced life expectancy.

An example of a technique to overcome the clogging of the nozzle 12 is disclosed in Japanese Patent Application Laid-Open No. 2009-248447. According to this technique, a pressure variation before and after an injection screw stops during injection is calculated. When the pressure variation is so large that a sudden pressure increase is considered to be caused, the injection screw is drastically decelerated and stopped and an alarm is generated.

In the technique described above, the increase of the pressure on an injection molding machine is detected by the generation of the alarm. Since the life of components cannot be reduced by the generation of only one or two alarms, however, it is uneconomical to replace the component based on the generation of such alarms. If the component continues to be used as it is, its metal fatigue progresses as an excessive pressure increase is repeated. Thus, the higher the incidence of abnormality, the shorter the component life may be.

Another example of the technique to overcome the clogging of the nozzle 12 is disclosed in Japanese Patent Application Laid-Open No. 4-110125. According to this technique, values indicative of various states in an injection molding process of an injection molding machine are detected as monitor data for each predetermined period, and the monitor data are analyzed for each predetermined period to obtain a transition trend for each data type. A maintenance warning is output when the obtained transition trend reaches a decision level set for consumable parts.

According to the technique described above, however, the maintenance warning is output based on the transition trend of the monitor data compared with the decision level. Therefore, the data can be detected when the states gradually change. In the case where abnormal states are randomly generated, however, the data sometimes cannot be properly extracted, so that the maintenance warning may fail to be accurately output.

In the prior art techniques, as described above, the timing for component replacement cannot be properly detected, so that the component replacement may be costly.

### SUMMARY OF THE INVENTION

Accordingly, the object of the present invention is to provide an injection molding system capable of improving molding conditions, extending component life, and reducing molding costs.

A first aspect of an injection molding system according to the present invention comprises an injection molding machine and a data management device, which are connected by a transmission unit for data transfer therebetween. The injection molding machine comprises: a fixed platen which holds a fixed-side mold; a movable platen which holds a movable-side mold and which is arranged facing the fixed platen and slidable by a mold clamping mechanism; and a cylinder arranged facing a surface opposite the surface of the fixed platen on which the fixed-side mold is mounted, wherein the cylinder is configured to melt a resin therein so that the resin is injected from a nozzle mounted on the distal end of the cylinder into a space between the fixed-side mold and the movable-side mold. The injection molding machine further comprises an abnormality detection unit configured to detect an abnormality of a pressure on the resin in the cylinder. The data management device comprises: a data storage unit configured to store abnormality detection data on the resin pressure, including a resin pressure value obtained when the abnormality of the resin pressure is detected by the abnormality detection unit and the time and date of detection of the resin pressure abnormality by the abnormality detection unit; a data analysis unit configured to analyze the abnormality detection data on the resin pressure; and/or a determination unit configured to determine whether or not to output an alarm, based on the result of analysis by the data analysis unit. The injection molding machine includes the data storage unit, the data analysis unit, and/or the determination unit which are not included in the data management device.

According to this aspect, the abnormality detection data on the resin pressure, including the resin pressure value obtained when the abnormality of the resin pressure is detected by the abnormality detection unit and the time and date of detection of the resin pressure abnormality by the abnormality detection unit, is stored, and whether or not to output the alarm is determined based on the result of analysis of the stored data. Thus, molding conditions can be appropriately improved and each component can be replaced based on the resin pressure value obtained when the abnormality of the resin pressure is detected and the time and date of the detection.

A second aspect of the injection molding system according to the present invention comprises an injection molding machine. The injection molding machine comprises: a fixed platen which holds a fixed-side mold; a movable platen which holds a movable-side mold and which is arranged facing the fixed platen and slidable by a mold clamping mechanism; and a cylinder arranged facing a surface opposite the surface of the fixed platen on which the fixed-side mold is mounted, wherein the cylinder is configured to melt a resin therein so that the resin is injected from a nozzle mounted on the distal end of the cylinder into a space between the fixed-side mold and the movable-side mold. On the other hand, the injection molding system comprising: an abnormality detection unit configured to detect an abnormality of a pressure on the resin in the cylinder; a data storage unit configured to store abnormality detection data on the resin pressure, including a resin pressure value obtained when the abnormality of the resin pressure is detected by the abnormality detection unit and the time and date of detection of the resin pressure abnormality by the abnormality detection unit; a data analysis unit configured to analyze the abnormality detection data on the resin pressure; and a determination unit configured to determine whether or not to output an alarm, based on the result of analysis of the abnormality detection data by the data analysis unit.

According to this aspect, the abnormality detection data on the resin pressure, including the resin pressure value obtained when the abnormality of the resin pressure is detected by the abnormality detection unit and the time and date of detection of the resin pressure abnormality by the abnormality detection unit, is stored, and whether or not to output the alarm is determined based on the result of analysis of the stored data. Thus, the molding conditions can be appropriately improved and each component can be replaced based on the resin pressure value obtained when the abnormality of the resin pressure is detected and the time and date of the detection.

In the first and second aspects of the injection molding machine, the abnormality detection unit may be configured to detect the pressure abnormality when a predetermined pressure value is reached by a detection value of the resin pressure or when an increase of the resin pressure exceeds a predetermined degree.

The determination unit can obtain a life index related to the life of a component of an injection unit based on the abnormality detection data on the resin pressure from the data analysis unit and output the alarm when the obtained life index is deviated from at least one preset reference value. According to this embodiment, the life index related to the component life is obtained and the alarm is output when the obtained life index is deviated from the reference value. Thus, the molding conditions can be appropriately improved and each component can be replaced by suitably setting the life index.

The life index may be the total number of detections of the abnormality of the resin pressure. According to this embodiment, the alarm is output based on the total number of detections of the abnormality of the resin pressure, so that the molding conditions can be appropriately improved and each component can be replaced by suitably setting the number of abnormality detections.

The life index may be a time difference between the time and date of an Nth (N: set integer of 2 or more) detection of the resin pressure abnormality and the time and date of an (N−1)th detection of the resin pressure abnormality. According to this embodiment, the alarm is output when the time interval between the resin pressure abnormality detections is reduced. Thus, the molding conditions can be appropriately improved and each component can be replaced by suitably setting a reference detection interval.

The life index may be the sum total of resin pressure values obtained at the time of detection of the resin pressure abnormality. According to this embodiment, the alarm is output based on an integrated pressure value obtained when the resin pressure abnormality is detected, so that the molding conditions can be appropriately improved and each component can be replaced by suitably setting the integrated pressure value.

The life index may be the total number of days when the resin pressure abnormality is detected. According to this embodiment, the alarm is output based on the total number of days when the resin pressure abnormality is detected, so that the molding conditions can be appropriately improved and each component can be replaced by suitably setting the total number of days.

A plurality of reference values may be used as the at least one reference value and different alarms are generated corresponding to different reference values, individually. According to this embodiment, the different alarms are generated in association with the individual reference values. Thus, if the molding conditions are continuously used without improvement despite the generation of the alarms, alarm warning can be issued in stages, so that the improvement of the molding conditions can be notified more effectively.

The alarm may be generated when the number of detections of the resin pressure abnormality during a predetermined period exceeds a reference value or when the ratio of the number of detections of the resin pressure abnormality during the predetermined period to the total number of detections exceeds a predetermined reference value. According to this embodiment, the alarm is generated when the resin pressure abnormality frequently occurs during the predetermined period, so that the frequent occurrence of the resin pressure abnormality during a specific period can be reported.

A password may be added to the abnormality detection data or the abnormality detection data may be stored in an encrypted form as the data storage unit stores the abnormality detection data. According to this embodiment, data alteration and data erasure due to a malfunction can be prevented by performing processing for data erasure prevention such as the addition of the password to the abnormality detection data or the encryption of the data.

The abnormality detection value of the resin pressure and the life index can be individually set for each component. According to this embodiment, a more appropriate reference value can be set for each component by individually setting the abnormality detection value and the life index for each component.

According to the present invention, the alarm is generated based on the analysis of the abnormality detection data, including the resin pressure value obtained when the abnormality of the resin pressure in the cylinder is detected by the abnormality detection unit and the time and date of detection of the abnormality, so that adjustment of the molding conditions can be encouraged to prevent shortening of the component life due to the detected abnormality of the resin pressure in the cylinder.

### BRIEF DESCRIPTION OF THE DRAWINGS

The above and other objects and features of the present invention will be obvious from the ensuing description of embodiments with reference to the accompanying drawings, in which:

FIG. 1 is a block diagram of a first embodiment of an injection molding system according to the present invention;

FIG. 2 is a flowchart showing a flow of processing for analysis and determination performed by the first embodiment of the injection molding system according to the present invention;

FIG. 3 is a flowchart showing a flow of processing for analysis and determination performed by the second embodiment of the injection molding system according to the present invention;

FIG. 4 is a flowchart showing a flow of processing for analysis and determination performed by the third embodiment of the injection molding system according to the present invention;

FIG. 5 is a flowchart showing a flow of processing for analysis and determination performed by the fourth embodiment of the injection molding system according to the present invention;

FIG. 6A is a histogram illustrating a fifth embodiment of the injection molding system according to the present invention and showing the frequency of abnormality detection per day or 24 hours;

FIG. 6B is a frequency distribution table for the same data as data in FIG. 6A;

FIG. 7 is a block diagram showing a first modification of the injection molding system shown in the block diagram of FIG. 1;

FIG. 8 is a block diagram showing a second modification of the injection molding system shown in the block diagram of FIG. 1;

FIG. 9 is a block diagram showing a third modification of the injection molding system shown in the block diagram of FIG. 1;

FIG. 10 is a block diagram showing a fourth modification of the injection molding system shown in the block diagram of FIG. 1;

FIG. 11 is a block diagram showing a fifth modification of the injection molding system shown in the block diagram of FIG. 1;

FIG. 12 is a block diagram showing a sixth modification of the injection molding system shown in the block diagram of FIG. 1;

FIG. 13 is a block diagram showing a seventh modification of the injection molding system shown in the block diagram of FIG. 1; and

FIG. 14 is a view showing an outline of the configuration of a conventional injection molding machine.

### DETAILED DESCRIPTION OF THE PREFERRED EMBODIMENTS

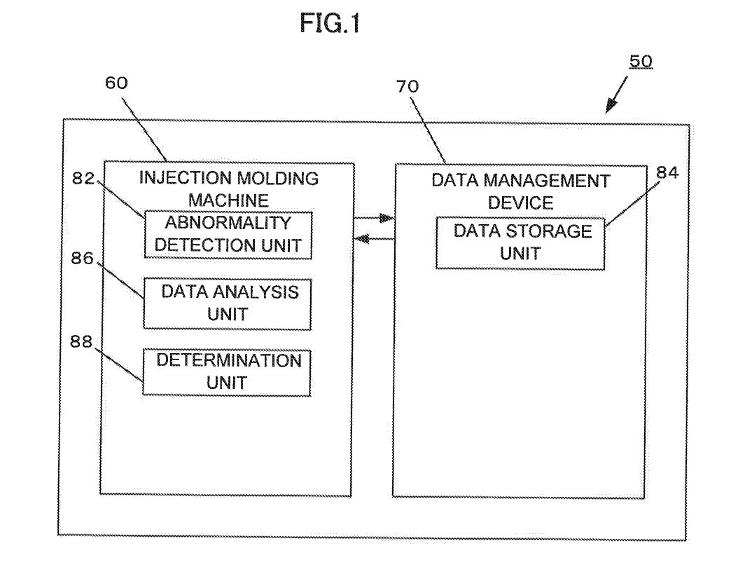

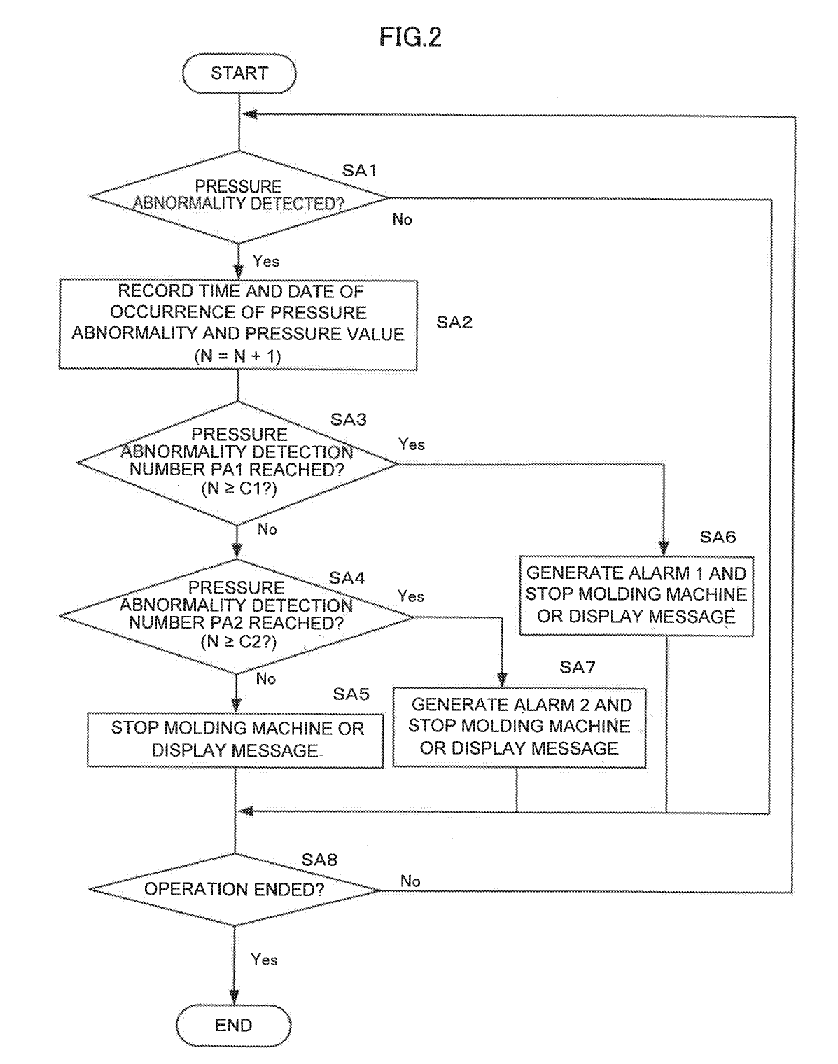

A first embodiment of an injection molding system according to the present invention will be described with reference to FIGS. 1 and 2. A conventional injection molding machine 60, such as that shown in FIG. 14, can be used for the injection molding system of the present embodiment.

An abnormality detection unit 82 is provided in a cylinder 11 of the injection molding machine 60. The abnormality detection unit 82 serves to detect a pressure on a resin in the cylinder 11. If the resulting detection value reaches a predetermined pressure value or if the increase of the resin pressure exceeds a predetermined degree, it can be determined to be abnormal. The resin pressure can be detected by using an in-nozzle resin pressure sensor, in-mold resin pressure sensor, or load current for an injection servomotor, besides a load cell of an electromotive injection molding machine for injection pressure control or a hydraulic measurement system of a hydraulic injection molding machine.

FIG. 1 is a block diagram of an injection molding system 50 according to the present embodiment.

The injection molding machine 60 and a data management device 70 are connected by means for data transmission and reception between them. The injection molding machine 60 comprises therein the abnormality detection unit 82 for detecting an abnormality of the resin pressure in the cylinder 11. Further, the data management device 70 comprises a data storage unit 84. The data storage unit 84 stores abnormality detection data on the resin pressure, including at least a resin pressure value obtained when the abnormality of the resin pressure in the cylinder 11 is detected by the abnormality detection unit 82 and the time and date of detection of the abnormality of the resin pressure in the cylinder 11. The data management device 70 can receive the detection value of the abnormality detection unit 82 in the injection molding machine 60 and transmit the content stored in the data storage unit 84 to the injection molding machine 60.

The injection molding machine 60 comprises a data analysis unit 86, configured to analyze the abnormality detection data on the resin pressure stored in the data storage unit 84, and a determination unit 88, which determines whether or not to output an alarm, based on the result of data analysis by the data analysis unit 86, in addition to the abnormality detection unit 82.

The following is a description of specific methods of analysis and determination performed by the injection molding system of FIG. 1. If the abnormality detection unit 82 detects such an abnormality that the resin pressure exceeds a predetermined tolerance during an injection operation, according to the present embodiment, the abnormality detection data on the resin pressure is stored in the data storage unit 84 in the data management device 70. Then, the analysis unit 86 counts the number of abnormalities detected by the abnormality detection unit 82. The determination unit 88 determines whether or not a set number of abnormality detections is reached by the counted number of abnormalities. If the set detection number is determined to be reached, an alarm is generated.

FIG. 2 is a flowchart showing a flow of processing for analysis and determination performed by the injection molding system of FIG. 1.

At the start of use (e.g., at the time of factory shipment) of the injection molding system or at the time of component replacement, C1 and C2 are set as pressure abnormality detection numbers PA1 and PA2, respectively, and N=0 is given. The following is a sequential description of steps shown in this flowchart.
Step SA1) In the abnormality detection unit 82, it is determined whether or not an abnormality of the resin pressure is detected. If the pressure abnormality is detected (Yes), the processing proceeds to Step SA2. If not (No), the processing proceeds to Step SA8.
(Step SA2) The time and date of occurrence of the pressure abnormality and a pressure value are recorded in the data storage unit 84, and 1 is added to the current value N, thereby updating N (N=N+1).
(Step SA3) It is determined whether or not C1 of the pressure abnormality detection number PA1 is reached by the number of detected pressure abnormalities. If C1 is reached (Yes), the processing proceeds to Step SA6. If not (No), the processing proceeds to Step SA4.
(Step SA4) It is determined whether or not C2 of the pressure abnormality detection number PA2 is reached by the number of detected pressure abnormalities. If C2 is reached (Yes), the processing proceeds to Step SA7. If not (No), the processing proceeds to Step SA5.
(Step SA5) The molding machine is stopped or a message is displayed, whereupon the processing proceeds to Step SA8.
(Step SA6) An alarm 1 is generated, and the molding machine is stopped or a message is displayed, whereupon the processing proceeds to Step SA8.
(Step SA7) An alarm 2 is generated, and the molding machine is stopped or a message is displayed, whereupon the processing proceeds to Step SA8.
(Step SA8) It is determined whether or not the operation is ended. If the operation is ended (Yes), this processing ends. If not (No), the processing returns to Step SA1.

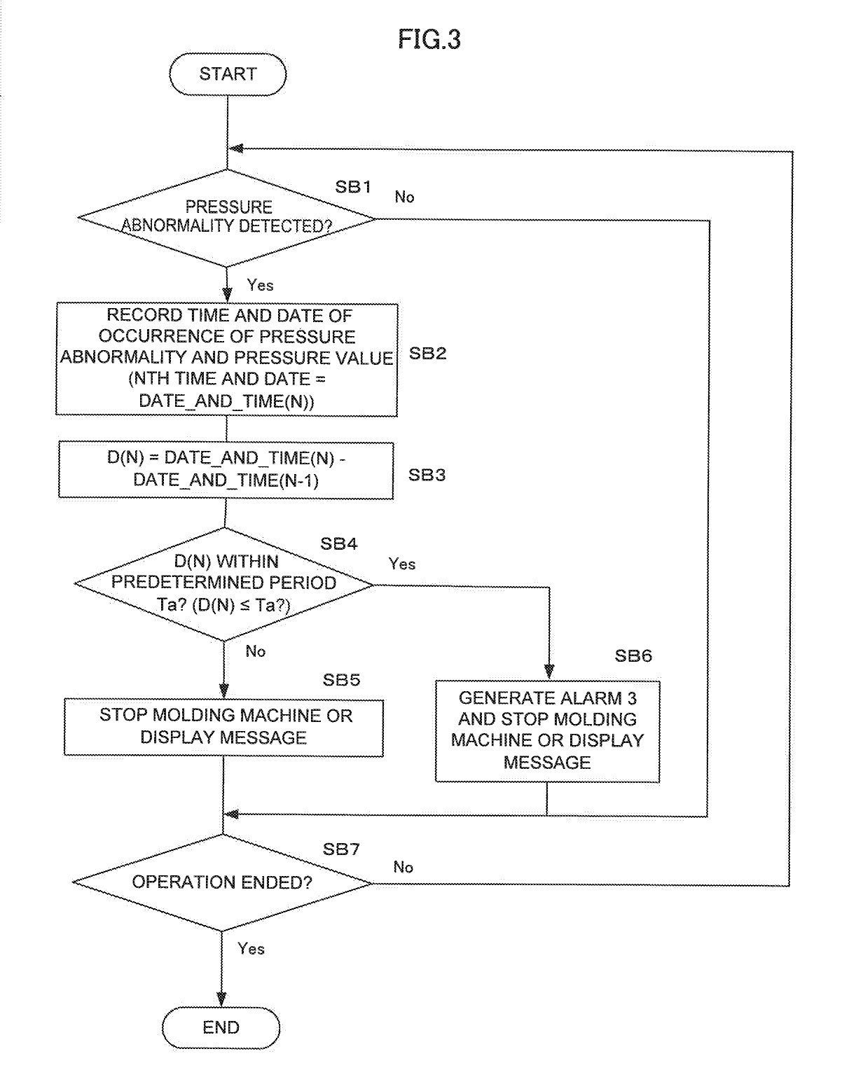

A second embodiment of the injection molding system according to the present invention will be described with reference to FIG. 3.

The present embodiment differs from the first embodiment in that the time and date of occurrence of a resin pressure abnormality is used for data analysis and an alarm is generated when the time interval at which resin pressure abnormalities occur becomes shorter than a predetermined period.

FIG. 3 is a flowchart showing a flow of processing for analysis and determination performed by the injection molding system of the present embodiment. A predetermined period Ta for the pressure abnormality time interval is set at the start of use (e.g., at the time of factory shipment) of the injection molding system or at the time of component replacement. The following is a sequential description of steps shown in this flowchart.
(Step SB1) In an abnormality detection unit 82, it is determined whether or not an abnormality of the resin pressure is detected. If the pressure abnormality is detected (Yes), the processing proceeds to Step SB2. If not (No), the processing proceeds to Step SB7.
(Step SB2) The time and date of occurrence of the pressure abnormality and a pressure value are recorded in a data storage unit 84. In doing this, an Nth time and date is represented by DATE_AND_TIME(N).
(Step SB3) A difference D(N) between the Nth time and date and an (N−1)th time and date is obtained (D(N)=DATE_AND_TIME(N)−DATE_AND_TIME(N−1)).
(Step SB4) The difference D(N) obtained in Step SB3 is compared with the predetermined period Ta. If D(N) is equal to or smaller than Ta (Yes), the processing proceeds to Step SB6. If not (No), the processing proceeds to Step SB5.
(Step SB5) The molding machine is stopped or a message is displayed, whereupon the processing proceeds to Step SB7.
(Step SB6) An alarm 3 is generated, and the molding machine is stopped or a message is displayed, whereupon the processing proceeds to Step SB7.
(Step SB7) It is determined whether or not the operation is ended. If the operation is ended (Yes), this processing ends. If not (No), the processing returns to Step SB1.

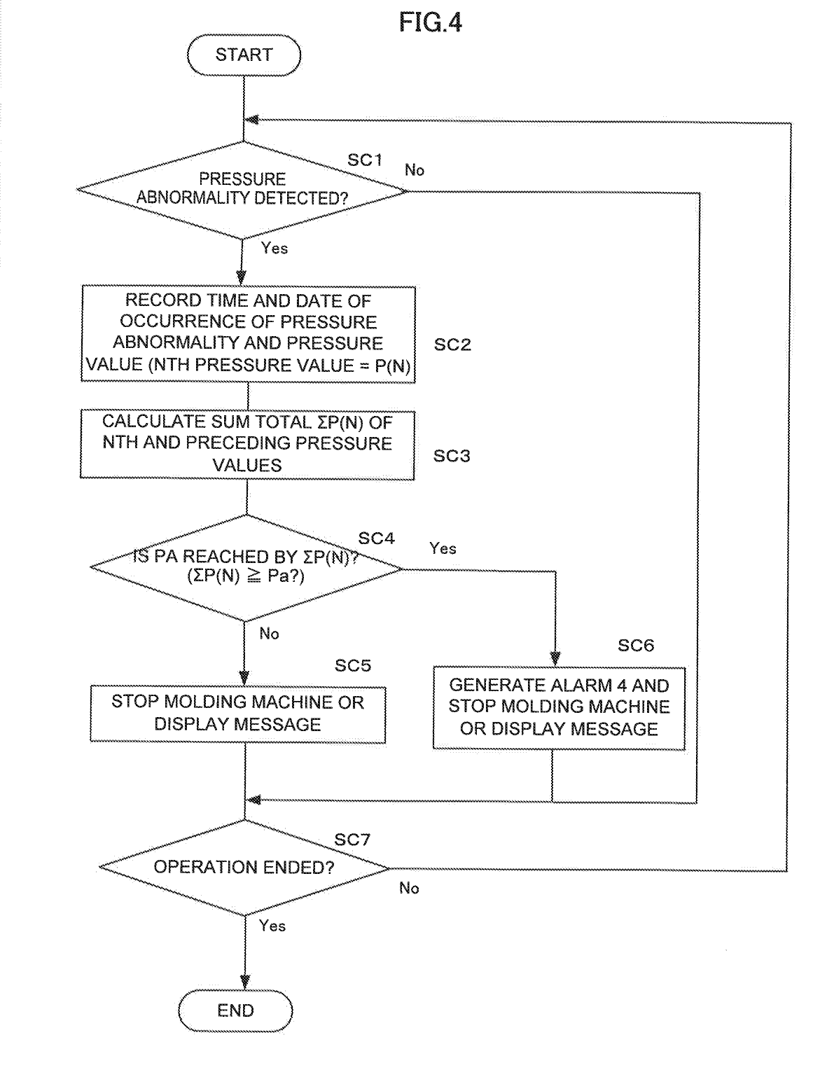

A third embodiment of the injection molding system according to the present invention will be described with reference to FIG. 4.

The present embodiment differs from the first and second embodiments in that pressure values for resin pressure abnormalities are used for data analysis and an alarm is generated when an integrated pressure value at the occurrence of a pressure abnormality reaches a total reference value.

FIG. 4 is a flowchart showing a flow of processing for analysis and determination performed by the injection molding system of the present embodiment. A total reference value Pa for pressure values is set at the start of use (e.g., at the time of factory shipment) of the injection molding system or at the time of component replacement. The following is a sequential description of steps shown in this flowchart.
(Step SC1) In an abnormality detection unit 82, it is determined whether or not an abnormality of the resin pressure is detected. If the pressure abnormality is detected (Yes), the processing proceeds to Step SC2. If not (No), the processing proceeds to Step SC7.
(Step SC2) The time and date of occurrence of the pressure abnormality and a pressure value are recorded in a data storage unit 84. In doing this, an Nth pressure value is represented by P(N).
(Step SC3) A sum total ΣP(N) of the Nth and preceding pressure values is calculated.
(Step SC4) It is determined whether or not the total reference value Pa is reached by the sum total ΣP(N) obtained in Step SC3. If the total reference value Pa is reached by ΣP(N) (Yes; ΣP(N)≧Pa), the processing proceeds to Step SC6. If not (No), the processing proceeds to Step SC5.
(Step SC5) The molding machine is stopped or a message is displayed, whereupon the processing proceeds to Step SC7.
(Step SC6) An alarm 4 is generated, and the molding machine is stopped or a message is displayed, whereupon the processing proceeds to Step SC7.
(Step SC7) It is determined whether or not the operation is ended. If the operation is ended (Yes), this processing ends. If not (No), the processing returns to Step SC1.

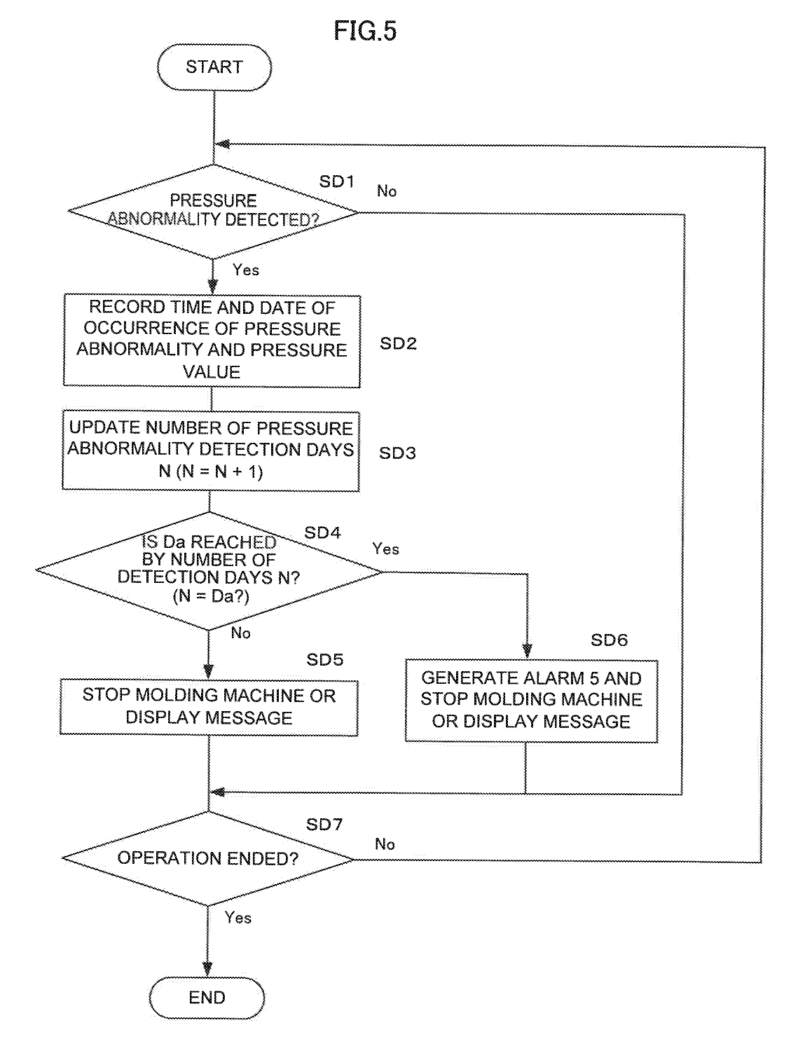

A fourth embodiment of the injection molding system according to the present invention will be described with reference to FIG. 5.

The present embodiment differs from the first to third embodiments in that the time and date of occurrence of a resin pressure abnormality is used for data analysis and an alarm is generated when the time and date of occurrence of the resin pressure abnormality reaches a predetermined number of days.

FIG. 5 is a flowchart showing a flow of processing for analysis and determination performed by the injection molding system of the present embodiment. Pressure abnormality detection days Da is set at the start of use (e.g., at the time of factory shipment) of the injection molding system or at the time of component replacement, and N is initialized to 0. The following is a sequential description of steps shown in this flowchart.
(Step SD1) In an abnormality detection unit 82, it is determined whether or not an abnormality of the resin pressure is detected. If the pressure abnormality is detected (Yes), the processing proceeds to Step SD2. If not (No), the processing proceeds to Step SD7.
(Step SD2) The time and date of occurrence of the pressure abnormality and a pressure value are recorded in a data storage unit 84.
(Step SD3) N indicative of the number of days on which pressure abnormality is detected (pressure abnormality detection days) is updated (N=N+1).
(Step SD4) It is determined whether or not a predetermined detection days Da of pressure abnormality is reached by the detection days N obtained in Step SD3. If the detection days Da of pressure abnormality is reached (Yes), the processing proceeds to Step SD6. If not (No), the processing proceeds to Step SD5.
(Step SD5) The molding machine is stopped or a message is displayed, whereupon the processing proceeds to Step SD7.
(Step SD6) An alarm 5 is generated, and the molding machine is stopped or a message is displayed, whereupon the processing proceeds to Step SD7.
(Step SD7) It is determined whether or not the operation is ended. If the operation is ended (Yes), this processing ends. If not (No), the processing returns to Step SD1.

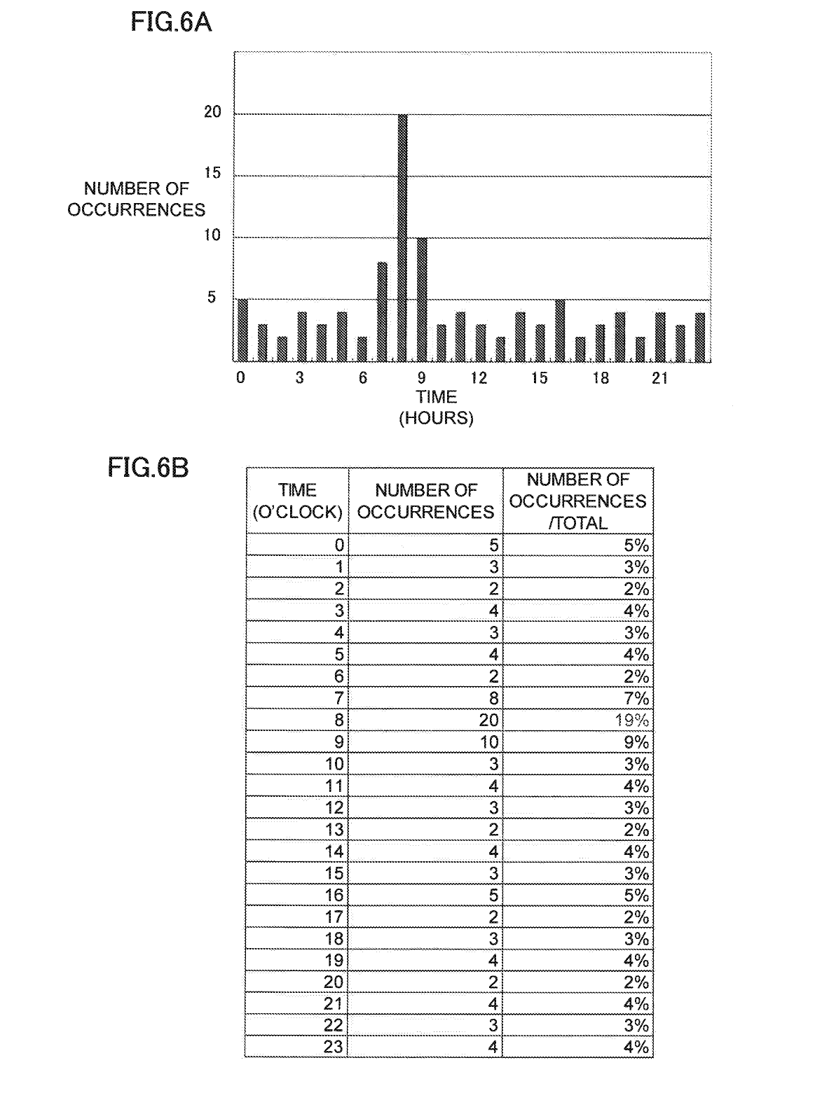

A fifth embodiment of the injection molding system according to the present invention will be described with reference to FIGS. 6A and 6B.

The present embodiment differs from the first embodiment in that the time and date of occurrence of a resin pressure abnormality and the number of occurrences of resin pressure abnormalities are used for data analysis and an alarm is generated when a value (indicative of the time interval at which resin pressure abnormalities occur) obtained by dividing data (number of occurrences) in a frequency distribution table or a histogram for the abnormality detection dates and times by the total number of abnormality detections becomes greater than a predetermined value.

FIG. 6A is a histogram showing the frequency of abnormality detection per day or 24 hours, and FIG. 6B is a frequency distribution table for the same data. In the present embodiment, a value (data on “NUMBER OF OCCURRENCES/TOTAL” of FIG. 6B) obtained by dividing data on each hour (from 00:00 to 23:00) in the frequency distribution table of FIG. 6B by the total number of abnormality detections during the day (24 hours) is used as a life index value.

An alarm 6 is generated when the number of abnormality detections generated on each hour (00:00, 01:00, . . . 23:00) reaches 10% of the total number, for example. In the present embodiment, the number of abnormality detections between 08:00 and 09:00 is 19% (>10%) of the total number of abnormality detections. Thus, it can be determined that abnormality detections are concentrated in the period from 08:00 to 09:00, and the alarm 6 can be generated to urge an operator or administrator to improve molding conditions.

In the present embodiment, moreover, the value obtained by dividing the data (number of occurrences of resin pressure abnormalities) on each hour by the total number of abnormality detections is used as the life index value. Alternatively, however, an alarm may be generated when the number of occurrences of resin pressure abnormalities on each hour exceeds a predetermined value. In the present embodiment, furthermore, a day (24 hours) is used as a period for the determination of the frequency of occurrence. However, this period is not limited to a day and may be some other period, such as a week, month, or year.

In these embodiments, a molding operator or an administrator of the molding machine and the data management device can also be kept from altering or erasing data when an abnormality is detected. Specifically, the abnormality detection data may be managed with a password or encrypted, or a data storage portion may be stored in a folder that is not easily accessible to the operator or administrator. Thus, data alteration and data erasure due to a malfunction can be prevented.

Although the alarms 1 to 6 of a plurality of types are used in these embodiments, the alarms need not always be varied in type, and an alarm of one type or a message may be displayed or the molding machine may be stopped.

In these embodiments, moreover, if an optimum abnormality detection value of the resin pressure and the life index are set for each component, the molding conditions can be more appropriately improved and each component can be replaced based on its life expectancy.

In the injection molding system according to each of the embodiments of the present invention described above, the injection molding machine 60 comprises the abnormality detection unit 82, data analysis unit 86, and determination unit 88, and the data management device 70 comprises the data storage unit 84. However, the present invention is not limited to this configuration and some modifications can be made. The following is a description of those modifications.

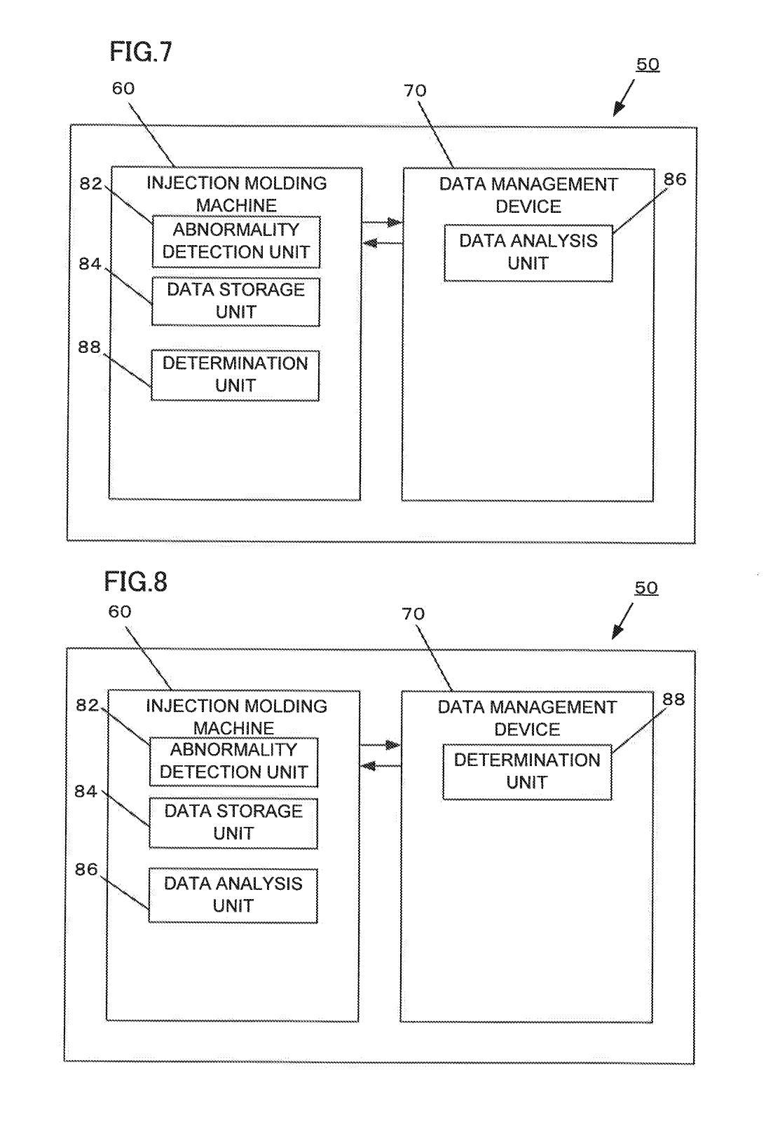

FIG. 7 shows a configuration example of the injection molding system 50 in which the injection molding machine 60 comprises the abnormality detection unit 82, data storage unit 84, and determination unit 88, and the data management device 70 comprises the data analysis unit 86.

Further, FIG. 8 shows a configuration example of the injection molding system 50 in which the injection molding machine 60 comprises the abnormality detection unit 82, data storage unit 84, and data analysis unit 86, and the data management device 70 comprises the determination unit 88.

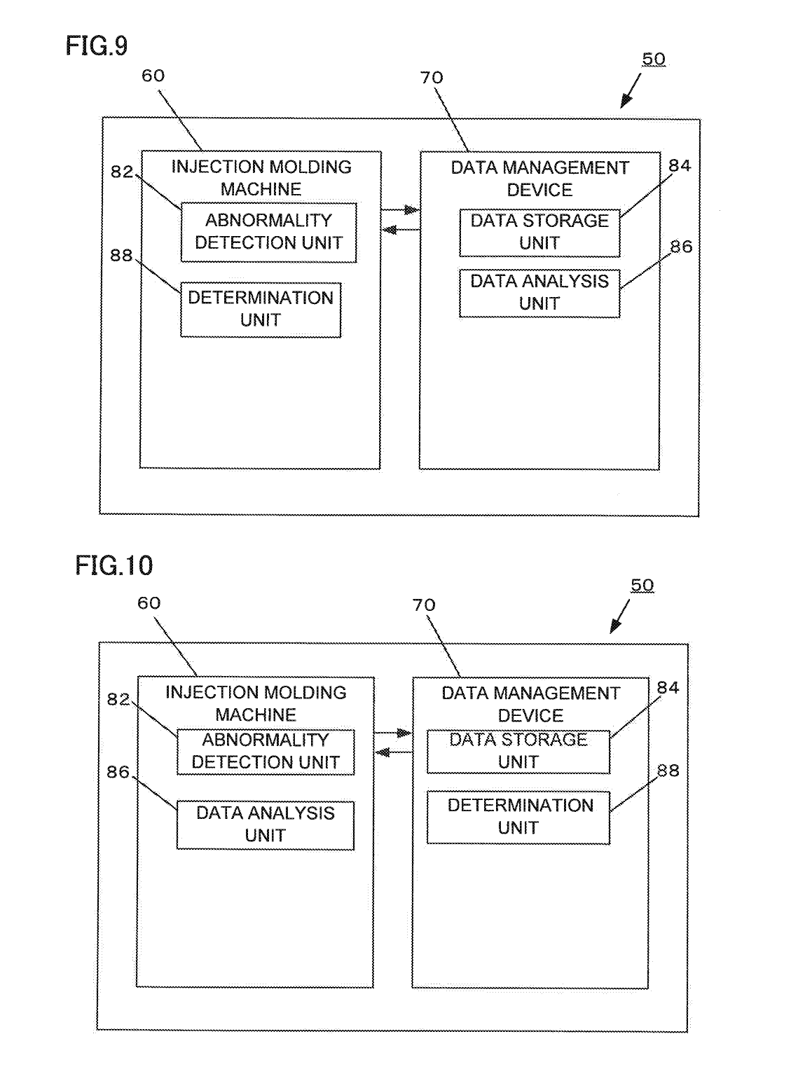

FIG. 9 shows a configuration example of the injection molding system 50 in which the injection molding machine 60 comprises the abnormality detection unit 82 and the determination unit 88, and the data management device 70 comprises the data storage unit 84 and the data analysis unit 86.

FIG. 10 shows a configuration example of the injection molding system 50 in which the injection molding machine 60 comprises the abnormality detection unit 82 and the data analysis unit 86, and the data management device 70 comprises the data storage unit 84 and the determination unit 88.

FIG. 11 shows a configuration example of the injection molding system 50 in which the injection molding machine 60 comprises the abnormality detection unit 82 and the data storage unit 84, and the data management device 70 comprises the data analysis unit 86 and the determination unit 88.

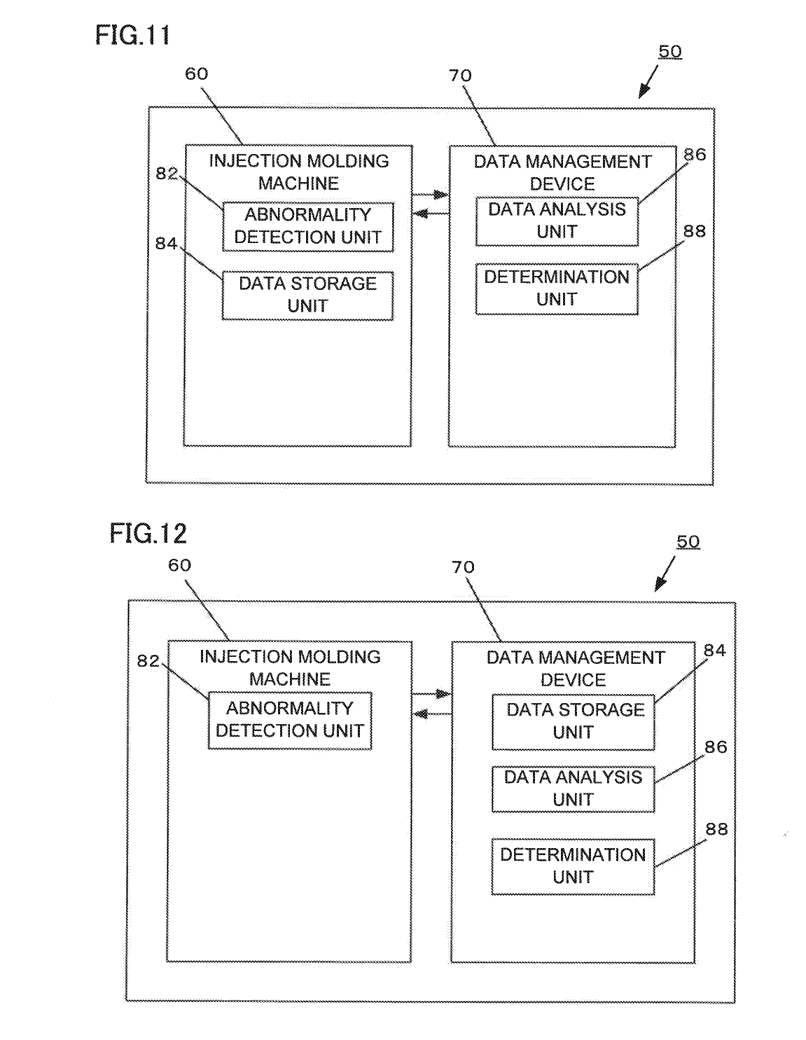

FIG. 12 shows a configuration example of the injection molding system 50 in which the injection molding machine 60 comprises the abnormality detection unit 82, and the data management device 70 comprises the data storage unit 84, data analysis unit 86, and determination unit 88.

The abnormality detection unit 82, data storage unit 84, data analysis unit 86, and determination unit 88 in the examples of the injection molding system shown in FIGS. 7 to 12 share the same functions with their counterparts in the first to fourth embodiments, although their locations are different. The abnormality detection unit 82 must be provided in the injection molding machine 60, as shown in FIGS. 7 to 12, since it is expected to detect the resin pressure in the cylinder. However, the data storage unit 84, data analysis unit 86, and determination unit 88 should only be provided in either the injection molding machine 60 or the data management device 70, only if data can be transferred as required between the injection molding machine 60 and the data management device 70. Further, the data management device 70 should only be connected to the injection molding machine 60 so that data can be transmitted and received.

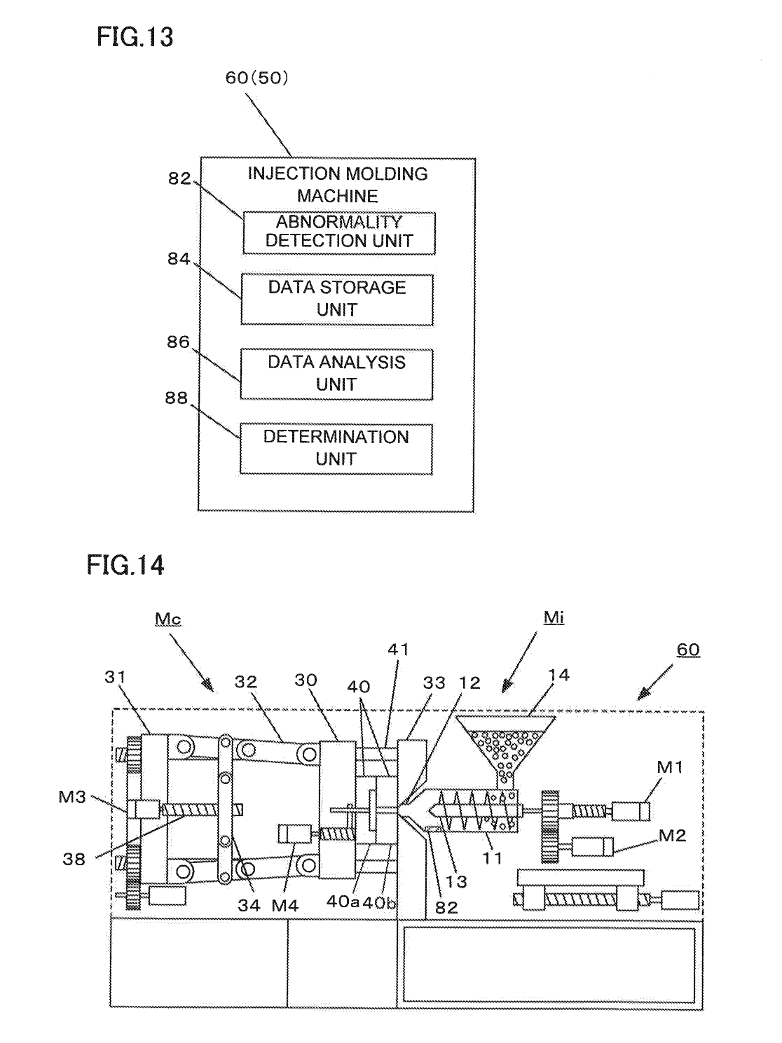

As shown in FIG. 13, moreover, the injection molding system 50 can be configured so that the injection molding machine 60 comprises the abnormality detection unit 82, data storage unit 84, data analysis unit 86, and determination unit 88. In this case, the injection molding machine 60 singly constitutes the injection molding system 50, and specific methods of analysis and determination similar to those of the first to fifth embodiments are applicable. In this case, furthermore, the data management device 70 need not be provided for data transfer with the injection molding machine 60.

1. An injection molding system comprising an injection molding machine and a data management device, which are connected by a transmission unit for data transfer therebetween,
the injection molding machine comprising:
a fixed platen which holds a fixed-side mold;
a movable platen which holds a movable-side mold and which is arranged facing the fixed platen and slidable by a mold clamping mechanism; and
a cylinder arranged facing a surface opposite the surface of the fixed platen on which the fixed-side mold is mounted,
wherein the cylinder is configured to melt a resin therein so that the resin is injected from a nozzle mounted on the distal end of the cylinder into a space between the fixed-side mold and the movable-side mold, and
the injection molding machine further comprises an abnormality detection unit configured to detect an abnormality of a pressure on the resin in the cylinder, and
the data management device comprising:
a data storage unit configured to store abnormality detection data on the resin pressure, including a resin pressure value obtained when the abnormality of the resin pressure is detected by the abnormality detection unit and the time and date of detection of the resin pressure abnormality by the abnormality detection unit;
a data analysis unit configured to analyze the abnormality detection data on the resin pressure; and/or
a determination unit configured to determine whether or not to output an alarm, based on the result of analysis by the data analysis unit,
wherein the injection molding machine includes the data storage unit, the data analysis unit, and/or the determination unit which are not included in the data management device.

2. An injection molding system comprising an injection molding machine,
the injection molding machine comprising:
a fixed platen which holds a fixed-side mold;
a movable platen which holds a movable-side mold and which is arranged facing the fixed platen and slidable by a mold clamping mechanism; and
a cylinder arranged facing a surface opposite the surface of the fixed platen on which the fixed-side mold is mounted,
wherein the cylinder is configured to melt a resin therein so that the resin is injected from a nozzle mounted on the distal end of the cylinder into a space between the fixed-side mold and the movable-side mold, and
the injection molding system comprising:
an abnormality detection unit configured to detect an abnormality of a pressure on the resin in the cylinder;
a data storage unit configured to store abnormality detection data on the resin pressure, including a resin pressure value obtained when the abnormality of the resin pressure is detected by the abnormality detection unit and the time and date of detection of the resin pressure abnormality by the abnormality detection unit;
a data analysis unit configured to analyze the abnormality detection data on the resin pressure; and
a determination unit configured to determine whether or not to output an alarm, based on the result of analysis of the abnormality detection data by the data analysis unit.

3. The injection molding system according to claim 1, wherein the abnormality detection unit detects the pressure abnormality when a predetermined pressure value is reached by a detection value of the resin pressure or when an increase of the resin pressure exceeds a predetermined degree.

4. The injection molding system according to claim 1, wherein the determination unit obtains a life index related to the life of a component of an injection unit based on the abnormality detection data on the resin pressure from the data analysis unit and outputs the alarm when the obtained life index is deviated from at least one preset reference value.

5. The injection molding system according to claim 4, wherein the life index is the total number of detections of the abnormality of the resin pressure.

6. The injection molding system according to claim 4, wherein the life index is a time difference between the time and date of an Nth (N: set integer of 2 or more) detection of the resin pressure abnormality and the time and date of an (N−1)th detection of the resin pressure abnormality.

7. The injection molding system according to claim 4, wherein the life index is the sum total of resin pressure values obtained at the time of detection of the resin pressure abnormality.

8. The injection molding system according to claim 4, wherein the life index is the total number of days when the resin pressure abnormality is detected.

9. The injection molding system according to claim 4, wherein a plurality of reference values are used as the at least one reference value and different alarms are generated corresponding to different reference values, individually.

10. The injection molding system according to claim 4, wherein the alarm is generated when the number of detections of the resin pressure abnormality during a predetermined period exceeds a reference value or when the ratio of the number of detections of the resin pressure abnormality during the predetermined period to the total number of detections exceeds a predetermined reference value.

11. The injection molding system according to claim 1, wherein a password is added to the abnormality detection data or the abnormality detection data is stored in an encrypted form as the data storage unit stores the abnormality detection data.

12. The injection molding system according to claim 1, wherein the abnormality detection value of the resin pressure and the life index are individually set for each component.
